(19) United States
(12) Patent Application Publication
(10) Pub. No.: US 2026/0210554 A1
(43) Pub. Date: Jul. 23, 2026

(54) BARBECUE OVEN WITH COMBUSTION FUNCTION

(71) Applicants: Jiajun CHEN, Shenzhen (CN); Foshan Sumor Intelligent Technology Co., Ltd, Foshan (CN)

(72) Inventor: Yongjie Wu, Fenghua (CN)

(73) Assignees: Jiajun CHEN, Shenzhen (CN); Foshan Sumor Intelligent Technology Co., Ltd, Foshan (CN)

(21) Appl. No.: 19/026,697

(22) Filed: Jan. 17, 2025

(51) Int. Cl. F24B 5/08; A47J 37/07

(52) U.S. Cl. CPC F24B 5/08; A47J 37/0704; A47J 37/0763

(57) ABSTRACT

A barbecue oven with a combustion function includes an oven body, a barbecue plate, a discharging hopper and a combustion hopper, wherein an air pressurizing channel is formed in a bottom of the oven body, an air inlet communicated with the outside of the oven body is formed inside the air pressurizing channel, and an air outlet of the air pressurizing channel is communicated with an inner cavity of the combustion hopper. In the barbecue oven, the air pressurizing channel is adopted to replace a chimney which has the function of lengthening a flame by a drawing force, and the air pressurizing channel can more quickly introduce air through thrust to lengthen the flame, such that a ventilation structure is optimized, and an occupied space of the barbecue oven is reduced.

### TECHNICAL FIELD

The present utility model relates to the field of barbecue oven manufacturing, and in particular, to a barbecue oven with a combustion function.

### BACKGROUND

A barbecue oven in the prior art includes an outer cover, a bottom plate and supporting legs, wherein the bottom plate and the outer cover are fixedly connected into a whole and form a cavity, a barbecue plate, a heat-conducting inner container and an inner container top plate are arranged in the cavity, the barbecue plate is provided at an upper end of the bottom plate and placed in the heat-conducting inner container, the heat-conducting inner container is provided with a heat-conducting hole, the heat-conducting inner container is provided with the inner container top plate, the inner container top plate is provided with a raised cylindrical hole, the cylindrical hole penetrates through the outer cover and a chimney base to be connected with a chimney, a front port of the cavity formed by fixedly connecting the bottom plate and the outer cover is provided with a door frame, a door is mounted on the door frame, a fire baffle is provided at a rear end of the barbecue plate, a back plate is provided at a rear end of the fire baffle, a rectangular hole is formed in an upper portion of the back plate, a discharging hopper with a bottom having an inclined structure is fixedly mounted at the rectangular hole, a hopper cover is fixedly mounted at an upper end of the discharging hopper, the hopper cover can be opened and closed, a combustion hopper is provided at a lower end of the discharging hopper, and the combustion hopper penetrates through the back plate to be placed at the rear end of the fire baffle. However, the barbecue oven is required to be provided with the chimney base and the chimney, the chimney occupies a large space, use is not ideal, and therefore, the structure of the barbecue oven is required to be further improved.

An objective of the present utility model is to provide, for the prior art, a barbecue oven with a combustion function in which barbecue flames can fully cover a barbecue plate in the oven to realize an even barbecue degree.

In order to achieve the above technical effect, the following technical solution is adopted in the present utility model:

a barbecue oven with a combustion function includes an oven body, a barbecue plate, a discharging hopper and a combustion hopper, wherein an air pressurizing channel is formed in a bottom of the oven body, an air inlet communicated with the outside of the oven body is formed inside the air pressurizing channel, an air outlet of the air pressurizing channel is communicated with an inner cavity of the combustion hopper, and when fuel is added into the combustion hopper and burnt to heat an inner cavity of the oven body, the air pressurizing channel enhances air pressure thrust applied to the combustion hopper by air, so as to lengthen a flame of the fuel.

As a further description of the above technical solution:

the air pressurizing channel is a transverse pressurizing groove, an opening at a front end of the pressurizing groove is the air inlet, a bottom plate is provided at the bottom of the oven body, a bottom plate notch communicated with the inside of the oven body and the inside of the pressurizing groove is formed in the bottom plate, the bottom plate notch is the air outlet, a front portion of a top opening of the pressurizing groove is sealed by the bottom plate, and a rear portion of the top opening of the pressurizing groove is communicated with the inner cavity of the combustion hopper through the bottom plate notch.

As a further description of the above technical solution:

a combustion hopper surrounding edge is provided at a position corresponding to the bottom plate notch, the combustion hopper is movably connected to the combustion hopper surrounding edge, a gap is reserved between a side wall of the combustion hopper and the combustion hopper surrounding edge, and a plurality of uniformly distributed air vents are formed in an inner bottom wall and the side wall of the combustion hopper.

As a further description of the above technical solution:

a rear end opening where the combustion hopper can be mounted is formed in the oven body, one end of the combustion hopper penetrates through the rear end opening to be inserted on the combustion hopper surrounding edge, a combustion hopper panel is fixedly mounted at an end of the combustion hopper away from the combustion hopper surrounding edge, and a size of the combustion hopper panel is matched with a size of the rear end opening.

As a further description of the above technical solution:

a front end opening of the oven body is provided with a front separating plate, the rear end opening of the oven body is provided with a rear separating plate, a heat-collecting cap is provided in the inner cavity of the oven body, a front end of the heat-collecting cap is fixedly connected with the front separating plate, a rear end of the heat-collecting cap is fixedly connected with the rear separating plate, and an inner container of the oven body is a cavity defined by the heat-collecting cap and the bottom plate.

As a further description of the above technical solution:

the discharging hopper has the following structure: a cap body opening is formed in a top surface of a rear portion of the heat-collecting cap, a shell opening is formed in a position corresponding to a shell of the oven body, a discharging baffle is provided between the cap body opening and the shell opening in a surrounding mode, and a detachable sealing cover is inserted on a discharging channel formed by the cap body opening, the shell opening and the discharging baffle.

As a further description of the above technical solution:

a top surface of the barbecue plate is higher than a bottom edge of the front end opening.

As a further description of the above technical solution:

supporting rods for supporting the oven body are fixedly mounted on two sides of the air pressurizing channel, and bottoms of the supporting rods are lower than a bottom surface of the air pressurizing channel.

As a further description of the above technical solution:

a supporting strip is provided on an inner wall of the inner container of the oven body, and the barbecue plate is detachably mounted on the supporting strip.

As a further description of the above technical solution:

a fire baffle is provided on the bottom plate of the oven body, and the fire baffle is located between the barbecue plate and the combustion hopper.

The present utility model has the following positive and beneficial technical effects: the air pressurizing channel is provided at the bottom of the oven body, and the air pressurizing channel can enhance the air pressure thrust applied to the combustion hopper by the air, so as to achieve an air pressurizing function, such that the flame during fuel combustion can be lengthened to fully cover the barbecue plate in the oven, and therefore, temperatures inside and outside a to-be-barbecued material have good consistency, the barbecue degree is uniform, and a barbecue effect is improved; the air pressurizing channel is adopted to replace a chimney which has the function of lengthening the flame by a drawing force, and the air pressurizing channel can more quickly introduce the air through the thrust to lengthen the flame, such that a ventilation structure is optimized, and an occupied space of the barbecue oven is reduced; meanwhile, since the air pressurizing channel is provided at the bottom of the oven body, the air pressurizing channel can be applied to barbecue ovens with different sizes and meanwhile can be applied to a charcoal stove, thus expanding an application range; since the ventilation structure can fully cover the barbecue plate in the oven, the chimney is omitted, and meanwhile, an electric apparatus of the barbecue plate is avoided, resulting in a simple structure, convenient manufacturing and a low manufacturing cost.

### BRIEF DESCRIPTION OF THE DRAWINGS

To describe the technical solutions in the embodiments of the present utility model or the prior art more clearly, the following briefly describes the accompanying drawings required for describing the embodiments or the prior art. Apparently, the accompanying drawings in the following description show merely some embodiments of the present utility model, and a person of ordinary skill in the art may still derive other drawings from these accompanying drawings without creative efforts. In the drawings:

FIG. 1 is a schematic diagram of an overall structure according to the present utility model;

FIG. 2 is a perspective view of FIG. 1 from another perspective according to the present utility model;

FIG. 3 is an exploded view of FIG. 2 according to the present utility model;

FIG. 4 is a front projection view of FIG. 1 according to the present utility model;

FIG. 5 is a cross section taken along line A-A of FIG. 4 according to the present utility model;

FIG. 6 is a sectional view of FIG. 5 from another perspective according to the present utility model;

FIG. 7 is a structural exploded view of FIG. 6 according to the present utility model;

FIG. 8 is another structural exploded view of FIG. 6 according to the present utility model; and

FIG. 9 is a further structural exploded view of FIG. 6 according to the present utility model.

In the drawings: 1. oven body; 11. bottom plate; 111. bottom plate notch; 12. combustion hopper surrounding edge; 13. rear end opening; 131. rear separating plate; 14. front end opening; 141. front separating plate; 15. heat-collecting cap; 16. discharging baffle; 17. supporting rod; 18. supporting strip; 19. fire baffle; 2. barbecue plate; 3. discharging hopper; 4. combustion hopper; 41. air vent; 42. combustion hopper panel; 5. air pressurizing channel; 51. air inlet; 6. sealing cover.

### DETAILED DESCRIPTION OF THE EMBODIMENTS

The preferred embodiments of the present utility model will be described below with reference to the accompanying drawings, and it should be understood that the embodiments described herein are merely for purposes of illustration and explanation of the present utility model, and are not intended to limit the present utility model.

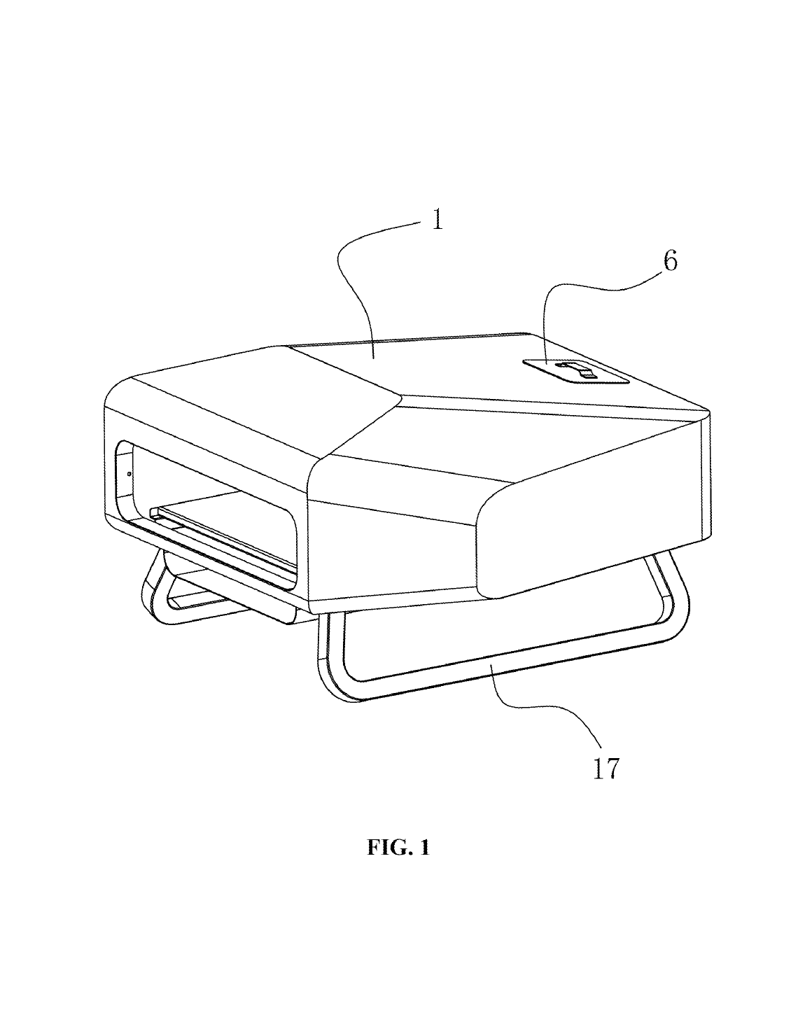

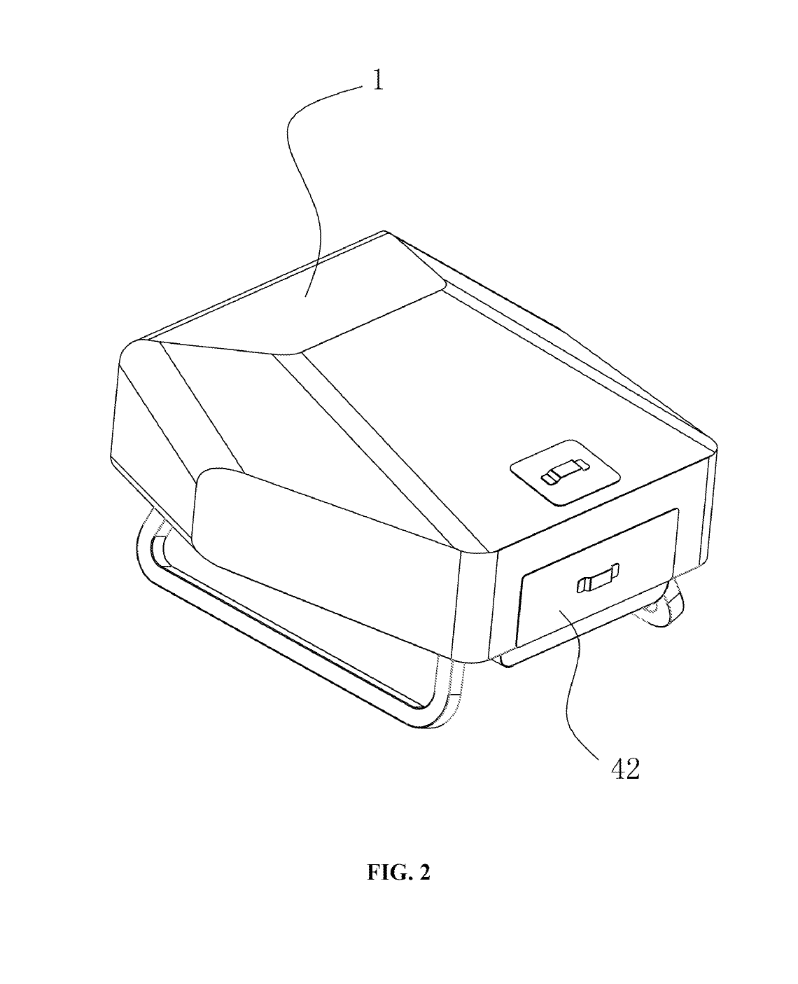

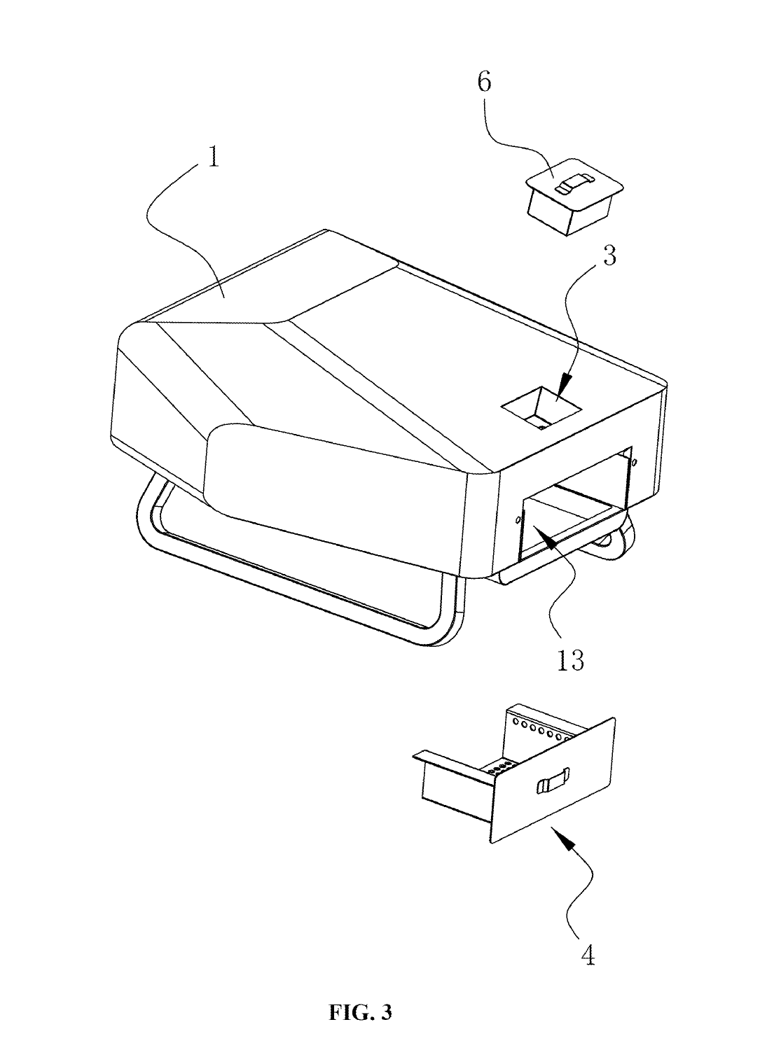

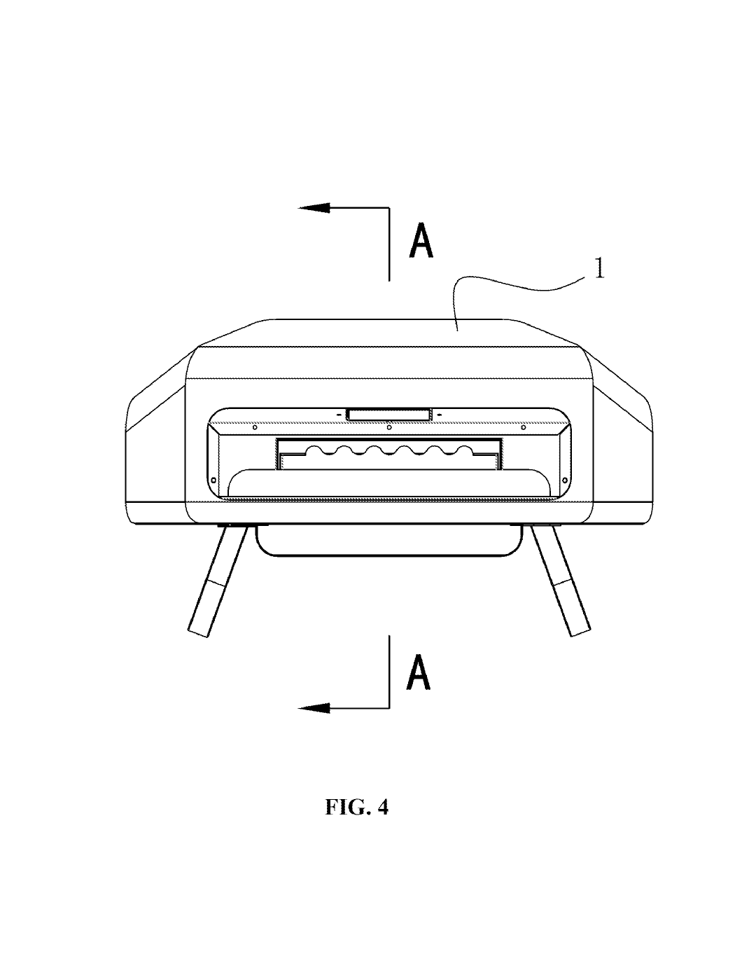

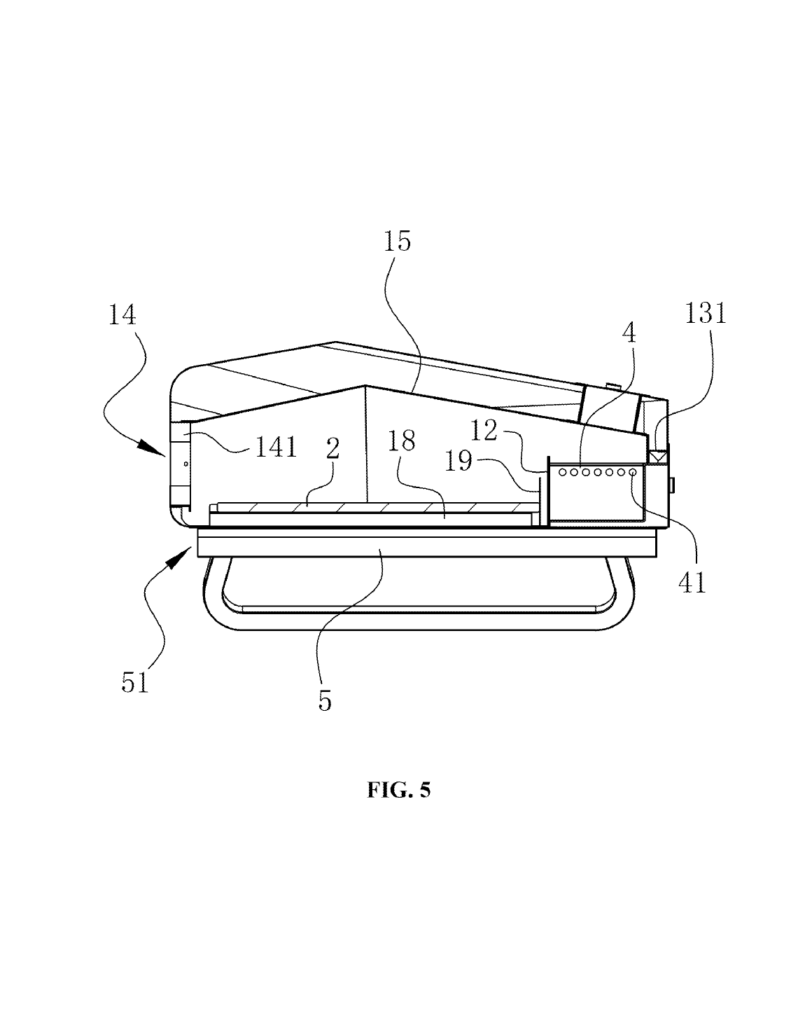

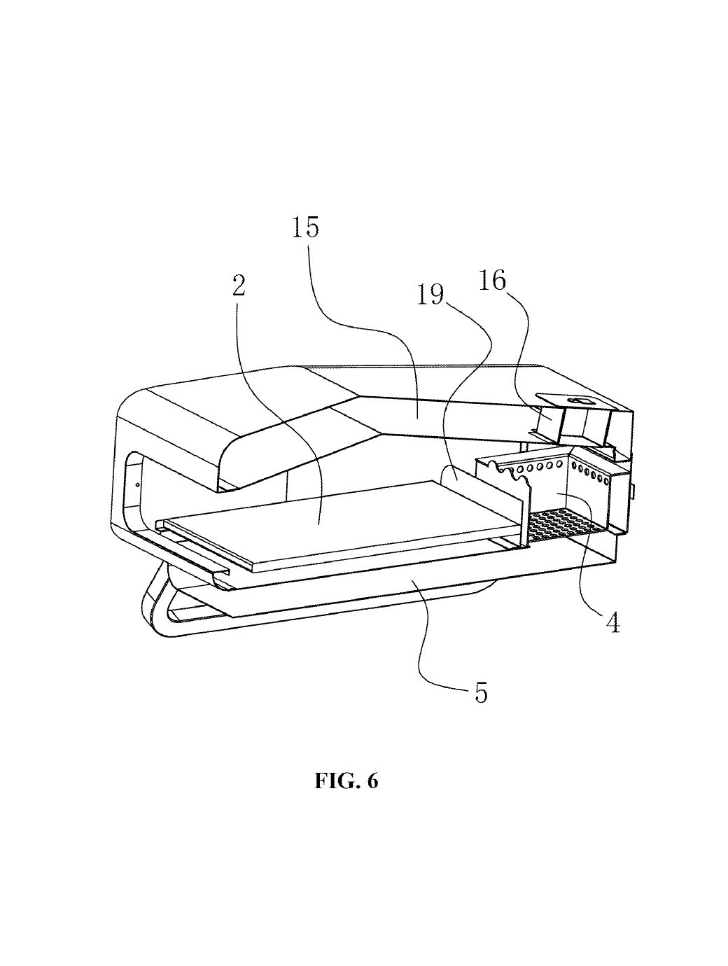

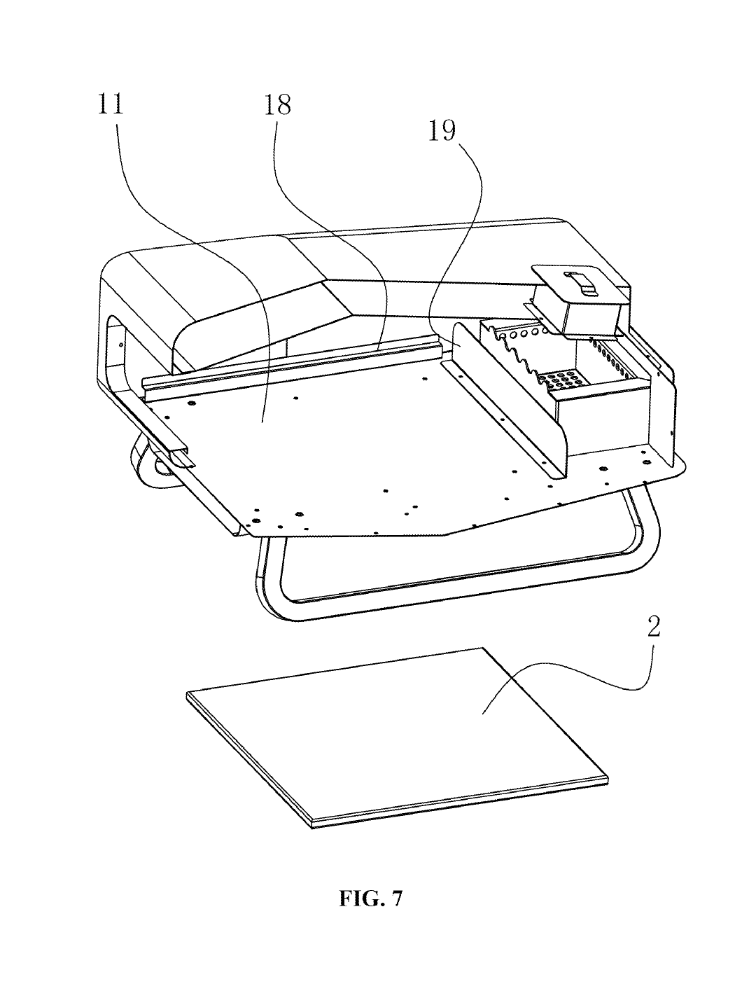

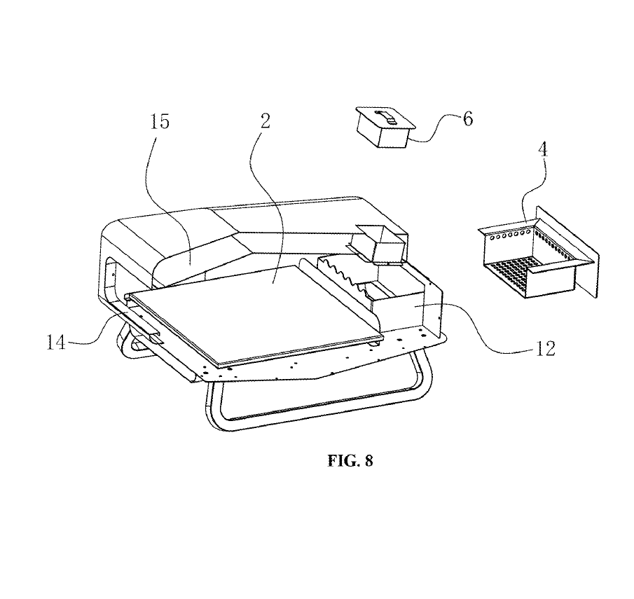

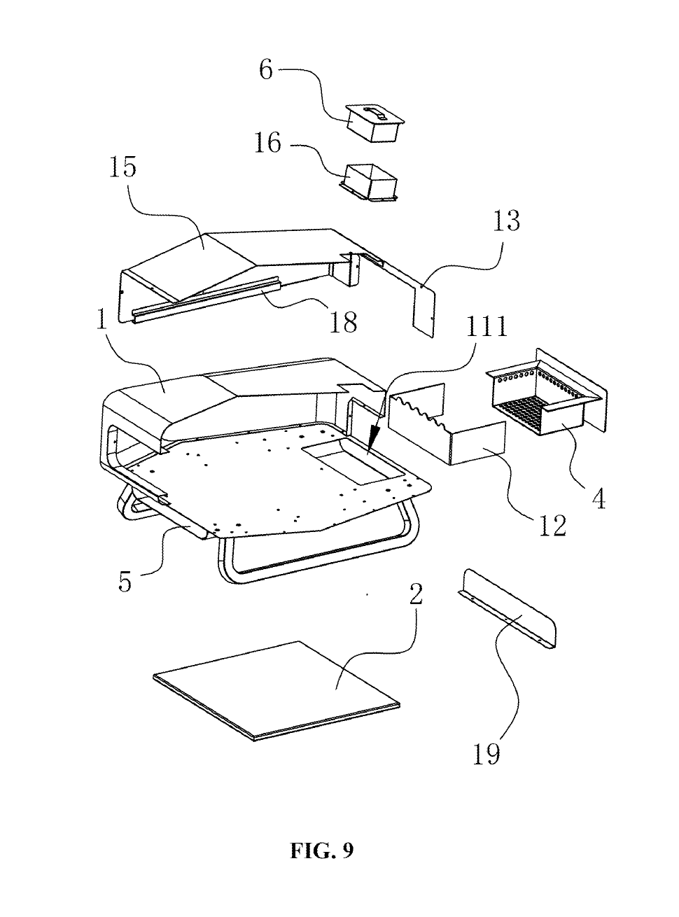

As shown in FIGS. 1 to 10, a barbecue oven with a combustion function includes an oven body 1, a barbecue plate 2, a discharging hopper 3 and a combustion hopper 4, wherein an air pressurizing channel 5 is formed in a bottom of the oven body 1, an air inlet 51 communicated with the outside of the oven body is formed inside the air pressurizing channel 5, an air outlet of the air pressurizing channel 5 is communicated with an inner cavity of the combustion hopper 4, and when fuel is added into the combustion hopper 4 and burnt to heat an inner cavity of the oven body, the air pressurizing channel 5 enhances air pressure thrust applied to the combustion hopper 4 by air, so as to lengthen a flame of the fuel.

The air pressurizing channel 5 is a transverse pressurizing groove, an opening at a front end of the pressurizing groove is the air inlet 51, a bottom plate 11 is provided at the bottom of the oven body 1, a bottom plate notch 111 communicated with the inside of the oven body 1 and the inside of the pressurizing groove is formed in the bottom plate 11, the bottom plate notch 111 is the air outlet, a front portion of a top opening of the pressurizing groove is sealed by the bottom plate 11, and a rear portion of the top opening of the pressurizing groove is communicated with the inner cavity of the combustion hopper through the bottom plate notch 111; a combustion hopper surrounding edge 12 is provided at a position corresponding to the bottom plate notch 111, the combustion hopper 4 is movably connected to the combustion hopper surrounding edge 12, a gap is reserved between a side wall of the combustion hopper 4 and the combustion hopper surrounding edge 12, and a plurality of uniformly distributed air vents 41 are formed in an inner bottom wall and the side wall of the combustion hopper 4; the discharging hopper 3 has the following structure: a cap body opening is formed in a top surface of a rear portion of a heat-collecting cap 15, a shell opening is formed in a position corresponding to a shell of the oven body 1, a discharging baffle 16 is provided between the cap body opening and the shell opening in a surrounding mode, and a detachable sealing cover 6 is inserted on a discharging channel formed by the cap body opening, the shell opening and the discharging baffle 16, such that air in the pressurizing groove can enter the combustion hopper 4, and then, the inside of the barbecue plate 2 can be heated evenly.

A front end opening 14 of the oven body 1 is provided with a front separating plate 141, a rear end opening 13 of the oven body 1 is provided with a rear separating plate 131, the heat-collecting cap 15 is provided in the inner cavity of the oven body, a front end of the heat-collecting cap 15 is fixedly connected with the front separating plate 141, a rear end of the heat-collecting cap 15 is fixedly connected with the rear separating plate 131, and an inner container of the oven body 1 is a cavity defined by the heat-collecting cap 15 and the bottom plate 11; the rear end opening 13 where the combustion hopper 4 can be mounted is formed in the oven body 1, one end of the combustion hopper 4 penetrates through the rear end opening 13 to be inserted on the combustion hopper surrounding edge 12, a combustion hopper panel 42 is fixedly mounted at an end of the combustion hopper 4 away from the combustion hopper surrounding edge 12, and a size of the combustion hopper panel 42 is matched with a size of the rear end opening 13, such that the combustion hopper 4 can be conveniently taken out from the oven body 1, and then, fuel can be conveniently stored.

A top surface of the barbecue plate 2 is higher than a bottom edge of the front end opening 14, a fire baffle 19 is provided on the bottom plate 11 of the oven body 1, and the fire baffle 19 is located between the barbecue plate 2 and the combustion hopper 4, such that the flame can conveniently heat the barbecue plate 2 from a lower part to achieve an even heating effect.

Supporting rods 17 for supporting the oven body 1 are fixedly mounted on two sides of the air pressurizing channel 5, and bottoms of the supporting rods 17 are lower than a bottom surface of the air pressurizing channel 5; a supporting strip 18 is provided on an inner wall of the inner container of the oven body 1, and the barbecue plate 2 is detachably mounted on the supporting strip 18, such that the oven body 1 and the barbecue plate 2 can be supported, thereby bringing more convenience in a barbecue process.

Working principle:

the air pressurizing channel can enhance the air pressure thrust applied to the combustion hopper by the air, so as to achieve an air pressurizing function, such that the flame during fuel combustion can be lengthened to fully cover the barbecue plate in the oven, and therefore, temperatures inside and outside a to-be-barbecued material have good consistency; the air pressurizing channel is adopted to replace a chimney which lengthens the flame by a drawing force, and the air pressurizing channel can more quickly introduce the air through the thrust to lengthen the flame, such that a ventilation structure is optimized, and an occupied space of the barbecue oven is reduced.

Although specific embodiments of the present utility model have been described above, it should be understood by those skilled in the art that these embodiments are merely illustrative and that various omissions, substitutions and changes in the details of the above method and system may be made by those skilled in the art without departing from the principle and essence of the present utility model. For example, it is within the scope of the present utility model to combine the above method steps to perform substantially the same function according to substantially the same method to achieve substantially the same result. Accordingly, the scope of the present utility model is defined only by the following claims.

What is claimed is:

1. A barbecue oven with a combustion function, comprising an oven body, a barbecue plate, a discharging hopper and a combustion hopper, wherein an air pressurizing channel is formed in a bottom of the oven body, an air inlet communicated with an outside of the oven body is formed inside the air pressurizing channel, an air outlet of the air pressurizing channel is communicated with an inner cavity of the combustion hopper, and when a fuel is added into the combustion hopper and burnt to heat an inner cavity of the oven body, the air pressurizing channel enhances an air pressure thrust applied to the combustion hopper by air to lengthen a flame of the fuel.

2. The barbecue oven with the combustion function according to claim 1, wherein the air pressurizing channel is a transverse pressurizing groove, an opening at a front end of the transverse pressurizing groove is the air inlet, a bottom plate is provided at the bottom of the oven body, a bottom plate notch communicated with an inside of the oven body and an inside of the transverse pressurizing groove is formed in the bottom plate, the bottom plate notch is the air outlet, a front portion of a top opening of the transverse pressurizing groove is sealed by the bottom plate, and a rear portion of the top opening of the transverse pressurizing groove is communicated with the inner cavity of the combustion hopper through the bottom plate notch.

3. The barbecue oven with the combustion function according to claim 2, wherein a combustion hopper surrounding edge is provided at a position corresponding to the bottom plate notch, the combustion hopper is movably connected to the combustion hopper surrounding edge, a gap is reserved between a side wall of the combustion hopper and the combustion hopper surrounding edge, and a plurality of uniformly distributed air vents are formed in an inner bottom wall and the side wall of the combustion hopper.

4. The barbecue oven with the combustion function according to claim 3, wherein a rear end opening is formed in the oven body, wherein the combustion hopper is configured to be mounted in the rear end opening, a first end of the combustion hopper penetrates through the rear end opening to be inserted on the combustion hopper surrounding edge, a combustion hopper panel is fixedly mounted at a second end of the combustion hopper away from the combustion hopper surrounding edge, and a size of the combustion hopper panel is matched with a size of the rear end opening.

5. The barbecue oven with the combustion function according to claim 4, wherein a front end opening of the oven body is provided with a front separating plate, the rear end opening of the oven body is provided with a rear separating plate, a heat-collecting cap is provided in the inner cavity of the oven body, a front end of the heat-collecting cap is fixedly connected with the front separating plate, a rear end of the heat-collecting cap is fixedly connected with the rear separating plate, and an inner container of the oven body is a cavity defined by the heat-collecting cap and the bottom plate.

6. The barbecue oven with the combustion function according to claim 5, wherein the discharging hopper has the following structure: a cap body opening is formed in a top surface of a rear portion of the heat-collecting cap, a shell opening is formed in a position corresponding to a shell of the oven body, a discharging baffle is provided between the cap body opening and the shell opening in a surrounding mode, and a detachable sealing cover is inserted on a discharging channel formed by the cap body opening, the shell opening and the discharging baffle.

7. The barbecue oven with the combustion function according to claim 5, wherein a top surface of the barbecue plate is higher than a bottom edge of the front end opening.

8. The barbecue oven with the combustion function according to claim 1, wherein supporting rods for supporting the oven body are fixedly mounted on two sides of the air pressurizing channel, and bottoms of the supporting rods are lower than a bottom surface of the air pressurizing channel.

9. The barbecue oven with the combustion function according to claim 1, wherein a supporting strip is provided on an inner wall of an inner container of the oven body, and the barbecue plate is detachably mounted on the supporting strip.

10. The barbecue oven with the combustion function according to claim 1, wherein a fire baffle is provided on a bottom plate of the oven body, and the fire baffle is located between the barbecue plate and the combustion hopper.

11. The barbecue oven with the combustion function according to claim 2, wherein supporting rods for supporting the oven body are fixedly mounted on two sides of the air pressurizing channel, and bottoms of the supporting rods are lower than a bottom surface of the air pressurizing channel.

12. The barbecue oven with the combustion function according to claim 3, wherein supporting rods for supporting the oven body are fixedly mounted on two sides of the air pressurizing channel, and bottoms of the supporting rods are lower than a bottom surface of the air pressurizing channel.

13. The barbecue oven with the combustion function according to claim 4, wherein supporting rods for supporting the oven body are fixedly mounted on two sides of the air pressurizing channel, and bottoms of the supporting rods are lower than a bottom surface of the air pressurizing channel.

14. The barbecue oven with the combustion function according to claim 5, wherein supporting rods for supporting the oven body are fixedly mounted on two sides of the air pressurizing channel, and bottoms of the supporting rods are lower than a bottom surface of the air pressurizing channel.

15. The barbecue oven with the combustion function according to claim 6, wherein supporting rods for supporting the oven body are fixedly mounted on two sides of the air pressurizing channel, and bottoms of the supporting rods are lower than a bottom surface of the air pressurizing channel.

16. The barbecue oven with the combustion function according to claim 7, wherein supporting rods for supporting the oven body are fixedly mounted on two sides of the air pressurizing channel, and bottoms of the supporting rods are lower than a bottom surface of the air pressurizing channel.

17. The barbecue oven with the combustion function according to claim 2, wherein a supporting strip is provided on an inner wall of an inner container of the oven body, and the barbecue plate is detachably mounted on the supporting strip.

18. The barbecue oven with the combustion function according to claim 3, wherein a supporting strip is provided on an inner wall of an inner container of the oven body, and the barbecue plate is detachably mounted on the supporting strip.

19. The barbecue oven with the combustion function according to claim 4, wherein a supporting strip is provided on an inner wall of an inner container of the oven body, and the barbecue plate is detachably mounted on the supporting strip.

20. The barbecue oven with the combustion function according to claim 5, wherein a supporting strip is provided on an inner wall of the inner container of the oven body, and the barbecue plate is detachably mounted on the supporting strip.
